(19) United States
(12) Patent Application Publication
(10) Pub. No.: US 2006/0183848 A1
(43) Pub. Date: Aug. 17, 2006

(54) Self-crosslinking high-molecular polyurethane dispersion

(76) Inventors: Alois Maier, Engelsberg (DE); Franz Wolfertstetter, Engelsberg (DE); Herbert Winkelmann, Garching (DE); Josef Weichmann, Pleiskirchen (DE); Alfred Kern, Kirchweidach (DE)

Correspondence Address: FULBRIGHT & JAWORSKI, LLP, 666 FIFTH AVE, NEW YORK, NY, 10103-3198, US

(21) Appl. No.: 10/565,328

(22) PCT Filed: Jul. 29, 2004
(86) PCT No.: PCT/EP04/08528

§ 371 Date: Jan. 20, 2006

(30) Foreign Application Priority Data
Jul. 30, 2003 (DE) 103 34 753.4

(51) Int. Cl. C08G 18/08

(52) U.S. Cl. 524/589

(57) ABSTRACT

The invention relates to a self-crosslinking, high-molecular polyurethane dispersion based on oxidatively drying diols and/or triols, and consisting of the reaction constituents (A) of an unsaturated fatty acid constituent for oxidative drying, (B) a polyol constituent, (C) a polyisocyanate constituent, (D) a solvent constituent, (E) a neutralisation constituent, (F) a siccative constituent, (G) a chain lengthening constituent, and water. The advantages of said polyurethane dispersion are the technically simple production thereof, whereby the properties of the polyurethane dispersion and the polyurethane films can be tailor-made by means of the polyol constituents, in addition to the excellent drying capacity thereof, and the other good application technology properties thereof such as hardness and chemical resistance during the use of the binding agent for high-grade lacquers and coatings.

The present invention relates to a self-crosslinking polyurethane dispersion based on oxidatively drying diols and triols, a process for preparing them and their use.

In many building-chemical applications, there is interest in binders for which a combination of physical and chemical drying can be utilized, for example alkyd resins.

Owing to their versatility and universal usability, alkyd resins are at the present time without doubt the most important group of synthetic binders for surface coatings. Alkyd resins are polycondensates or polyesters derived from polycarboxylic acids or polycarboxylic anhydrides and polyalcohols and have been modified with oils or fatty acids. The range of possible variations of alkyd resins in respect of structure and composition is extraordinarily wide.

As raw materials, it is naturally possible to use triglycerides (oils, fats) or defined synthetic fatty acids. The property profile of the alkyd resins depends on the type and amount of long-chain fatty acids or oils present. Depending on the degree of unsaturation, a distinction is made between drying, semidrying and nondrying fatty acids or oils. Depending on the content of oils, a distinction is made between short oil alkyd resins, medium oil alkyd resins and long oil alkyd resins.

The film formation of drying alkyd resins is based on an increase in the molecular mass resulting from chemical crosslinking of the unsaturated fatty acids. This polymerization is induced by autooxidation processes (known as autoxypolymerization). To accelerate the autooxidative drying and film formation catalytically, active and auxiliary dryers or siccatives, which are metal salts of organic acids, are generally added to the alkyd resins.

The range of alkyd resins is widened further by modification with other components such as styrene, polyisocyanates, phenolic resins, epoxides, silicones. In the preparation of urethane alkyd resins or urethane alkyds, hydroxyl-containing, long oil alkyd resins are reacted with polyisocyanates in suitable organic solvents until there are no longer any free isocyanate groups present (NCO/OH≈0.95). These solvent-containing urethane alkyds are particularly useful for high-quality coatings, primers, paints and varnishes, sealants and are characterized by rapid drying, high hardness, excellent mechanical strength, very good abrasion resistance, high water resistance, improved resistance to chemicals.

Due to environmental pollution caused by solvent emissions and with a view to keeping within existing emission guidelines, considerable efforts have been made in recent years to develop water-dilutable binders for paints and varnishes and coatings which have a very low content of volatile organic compounds (VOC).

Oxidatively drying polyurethane dispersions modified with fatty acids represent a synergistic combination of alkyd resins and polyurethane resins which combine the excellent property profile of the two types of polymers. These self-crosslinking aqueous polyurethane dispersions can be prepared without solvents (zero VOC) or with a low solvent content (low VOC) and are therefore considerably more environmentally friendly than conventional solvent-containing urethane alkyds.

Depending on the requirement profile, one-component or two-component systems can be used. The performance of the paints and varnishes and coatings produced from oxidatively drying polyurethane dispersions is suitable for many applications.

The preparation of polyurethane dispersions modified with fatty acids and oxidatively drying polyurethane dispersions and their use in one-component and two-component systems is known.

EP-A 379 007 describes polyurethane dispersions based on oxidatively drying alkyd resins. With the exception of the relatively slow drying, these binders are characterized by a high level of properties.

EP-A 451 647 discloses polyurethane dispersions based on oxidatively drying alkyd resins which have disadvantages owing to the high solvent content, the high viscosity and the high loading. In the process of EP-A 640 632 and EP-A 647 665, drying oils are transesterified with polyols to give monoglycerides and used for preparing oxidatively drying polyurethane dispersions.

EP-A 729 991 discloses hydroxyl-containing polyurethane dispersions based on oxidatively drying alkyd resins which are suitable for producing one-component or two-component coating agents. However, these binders give good results only in two-component processing in combination with hardeners.

DE-A 36 30 422 describes the reaction of partially epoxidized drying oils with polyols and their use for preparing polyurethane dispersions. These polyurethane dispersions have only poor drying capabilities.

DE-A 42 37 965 discloses hydrogenated dimeric fatty acids or dimeric diols for preparing polyurethane dispersions which are processed in combination with hardeners under baking conditions. According to

DE-A 44 45 199, polyurethane dispersions are prepared on the basis of fatty acid-modified and oxidatively drying polyhydroxypolyesteramides and polyurethane prepolymers.

EP-A 444 454 discloses air-drying polyurethane resins which have been prepared by reaction of isocyanates with polyols bearing air-drying groups and with low molecular weight polyols and carboxyl-containing polyols. The polyurethane resins have a molecular mass of from about 1600 to 30 000 dalton. These systems require a comparatively high content of internal emulsifiers to stabilize them. In addition, film formation occurs exclusively by chemical drying (oxidative drying).

Oxidatively drying polyurethane dispersions modified with fatty acids are prepared using short to medium oil alkyd resins which have terminal hydroxyl groups which are reactive toward polyisocyanates. The alkyd resins are used in pure form or as solutions in organic solvents. In addition, the alkyd resins can be provided with ionic or nonionic internal emulsifiers. To increase the initial chemical resistance (pre-crosslinking) of the coatings produced from the polyurethane dispersions, use is frequently made of air-drying alkyd resins having a hydroxyl functionality F of >2. Apart from the alkyd resins, further polymeric polyols can also be present in the polyurethane backbone. During drying, crosslinking of the poly-urethane or polyurethane-polyurea polymers modified with fatty acids takes place in the presence of atmospheric oxygen and siccatives (post-crosslinking).

Possible variations in the synthesis are the prepolymer mixing process (low VOC), the solvent process (zero VOC) or combinations of these processes. In the synthesis of the polyurethane prepolymers, a functionality F of <2.5 is usually sought in order to avoid gellation and to keep the viscosity low or maintain the solubility of the prepolymer in the solvents used.

However, the synthesis of these oxidatively drying polyurethane dispersions modified with alkyd resins is associated with various problems. When the prepolymer mixing process is used, large amounts of internal emulsifiers and solvents are required. This is due to the high viscosity of the polyurethane prepolymers and the hydrophobicity of the alkyd resins. These problems are usually overcome by carrying out the synthesis by means of the solvent process or combinations of the prepolymer mixing process and the solvent process. However, these processes are significantly more complicated and costly than the prepolymer mixing process, since the solvent required for preparing the polyurethane dispersion has to be removed by distillation after the synthesis is completed. In addition, the proportion of unsaturated fatty acids is usually lower compared to conventional urethane-alkyd resins and this results in slower drying.

DE-A-198 58 554 discloses self-crosslinking polyurethane-polymer hybrid dispersions based on oxidatively drying polyols which have a high film hardness. These are obtained from the reaction components (A) from 0.3 to 12% by weight of an unsaturated fatty acid component which is capable of oxidative drying and comprises at least one unsaturated fatty acid derivative or fatty acid epoxy ester having two or more hydroxyl groups which are reactive toward polyisocyanates, (B) from 1.5 to 18% by weight of a polyol component, (C) from 3.5 to 16% by weight of a polyisocyanate component, (D) from 0 to 2% by weight of a siccative component, (E) from 0 to 8% by weight of a solvent component, (F) from 0.3 to 2.5% by weight of a neutralization component, (G) from 0.1 to 1.5% by weight of a chain extension component, (H) from 5 to 45% by weight of a monomer component, (I) from 0.05 to 2% by weight of an initiator component and water as balance. A disadvantage of this polyurethane-polymer hybrid dispersion is that the chemical resistance is too low in certain applications.

It was therefore an object of the present invention to develop a self-crosslinking polyurethane dispersion which is based on oxidatively drying diols and/or triols and is distinguished from the known prior art by a simple method of synthesis and at the same time improved properties, in particular an increased chemical resistance.

This object has been achieved according to the invention by the polyurethane dispersion comprising the reaction components

(A) from >12 to 30% by weight of an unsaturated fatty acid component which is capable of oxidative drying and comprises at least one unsaturated fatty acid derivative or fatty acid epoxy ester having two or three reactive hydroxyl groups,

(B) from 2 to 11% by weight of a polyol component comprising
(i) from 0 to 0.15% by weight of at least one low molecular weight polyol having two or more reactive hydroxyl groups and a molecular mass of from 60 to 150 dalton,
(ii) from 0.8 to 6% by weight of at least one higher molecular weight polyol having two or more reactive hydroxyl groups and a molecular mass of from 500 to 4000 dalton,
(iii) from 1.2 to 3.5% by weight of at least one anionically modified polyol having two or more reactive hydroxyl groups and one or more carboxyl groups which are inert toward polyisocyanates,

(C) from 8 to 25% by weight of a polyisocyanate component comprising at least one polyisocyanate or polyisocyanate derivative having two or more aliphatic or aromatic isocyanate groups,

(D) from 0 to 10% by weight of a solvent component comprising at least one solvent which is inert toward polyisocyanates or is completely or partially miscible with water,

(E) from 0.5 to 3% by weight of a neutralization component comprising a base based on an amine or hydroxide,

(F) from 0 to 0.5% by weight of a siccative component comprising at least one water-emulsifiable active or auxiliary dryer,

(G) from 0.5 to 3% by weight of a chain extension component comprising at least one polyamine having two or more reactive amino groups, and also water as balance.

It has surprisingly been found that the polyurethane dispersion of the invention is relatively simple to prepare and ensures a good drying capability as a result of the high proportion of unsaturated fatty acids even at a low added amount or a high NCO/OH ratio. In addition, the contents of internal emulsifiers and solvents can be kept low compared to conventional low-solvent products in the preparation of the polyurethane dispersion of the invention as a result of the low viscosity of the polyurethane prepolymers.

The component (A) capable of oxidative drying, which is present in a proportion of from >12 to 30% by weight, preferably from >12, particularly preferably from >13 and most preferably from >14, to 20% by weight, comprises at least one unsaturated fatty acid derivative which has two or three hydroxyl groups which are reactive toward polyisocyanates and is prepared from unsaturated fatty acids and aliphatic or aromatic epoxy resins or polyepoxides having two or three epoxide groups which are reactive toward fatty acids. These fatty acid derivatives or fatty acid epoxy esters are obtained, for example, by stoichiometric reaction of at most triply unsaturated fatty acids and aliphatic or aromatic epoxy resins or polyepoxides at temperatures of at least 140° C. in the presence of tetraalkylammonium halides as catalysts. In this addition reaction, the carboxyl groups of the unsaturated fatty acids react with the epoxide groups of the epoxy resins to form low molecular weight polyols modified with fatty acids. The component (A) preferably has an iodine number of from 100 to 150 g I₂. (100 g)⁻¹, a hydroxyl number of from 120 to 150 mg KOH·g⁻¹ and an acid number of from 1 to 5 mg KOH·g⁻¹. The viscosity is preferably from 2500 to 25 000 mPa·s (20° C.)

The term “unsaturated fatty acids” refers to commercial mixtures of predominantly multiply unsaturated fatty acids which can be obtained from drying oils by saponification and refining. Drying oils are naturally occurring fats and oils which have a high proportion of multiply unsaturated monocarboxylic acids in the triglyceride compound. A good drying capability is ensured by unsaturated fatty acids having a high proportion of monocarboxylic acids having 18 carbon atoms and 2 or 3 double bonds per molecule, e.g. linoleic acid (9,12-octadecadienoic acid) and linolenic acid (9,12,15-octadecatrienoic acid). Suitable unsaturated fatty acids are, for example, linseed oil fatty acid, conophor oil fatty acid, lallemantia oil fatty acid, stilingia oil fatty acid, soybean oil fatty acid, safflower oil fatty acid, conjuene fatty acids, ricinene fatty acids, but preferably linseed oil fatty acid having an acid number of from 198 to 202 mg KOH·g⁻¹ and an iodine number of from 170 to 190 g I₂·(100 g)⁻¹.

Epoxy resins or polyepoxides are obtained by reaction of epichlorohydrin with polyalcohols or polyamines having active hydrogen atoms or by epoxidation of unsaturated compounds. Suitable polyepoxides are, for example, the polyfunctional glycidyl derivatives of 2,2′-bis(4-hydroxyphenyl)propane (bisphenol A), 2,2′-bis(4-hydroxyphenyl)methane (bisphenol F), 1,1,2,2-tetrakis(4-hydroxyphenyl)ethane, phenol-formaldehyde condensates of the Novolak type, 1,4-butanediol, 1,4-bis(hydroxymethyl)cyclohexane (cyclohexanedimethanol), 1,2,3-propanetriol (glycerol), 2-ethyl-2-hydroxymethyl-1,3-propanediol (trimethylol-propane), aminobenzene, 4-aminophenol, 2,4,6-tri-hydroxy-1,3,5-triazine (isocyanuric acid) obtained by reaction with epichlorohydrin. For the present purposes, glycidyl derivatives are epoxy resins or polyepoxides. Preference is given to using polyepoxides having an epoxide number of greater than 0.5 eq·(100 g)⁻¹.

Polyepoxides based on bisphenol A and bisphenol F, e.g. bisphenol A diglycidyl ether and bisphenol F diglycidyl ether are particularly suitable for oxidatively drying diols and polyepoxides based on 2,4,6-trihydroxy-1,3,5-triazine, e.g. tris(2,3-epoxypropyl) isocyanurate or 1,3,5-tris(2,3-epoxypropyl)-1,3,5-trihydrotriazine-2,4,6-trione are particularly suitable for oxidatively drying triols. The chemistry of the epoxy resins is described in detail in the manual “Chemistry and Technology of Epoxy Resins” by B. Ellis (Editor), Blackie Academic & Professional, Glasgow 1993.

The component (B), which is present in a proportion of from 2 to 11% by weight, is a combination of low molecular weight, higher molecular weight and dispersible polyols.

The component (B) (i), which is present in a proportion of from 0 to 1.5% by weight and preferably from 0.4 to 1% by weight, comprises at least one low molecular weight polyol having a molecular mass of from 60 to 150 dalton, in particular from 90 to 140 dalton, and two or more, e.g. two, three or four hydroxyl groups which are reactive toward polyisocyanates. Suitable low molecular weight polyols which can be used are, for example, 1,2-ethanediol (ethylene glycol), 1,2-propanediol (1,2-propylene glycol), 1,3-propanediol (1,3-propylene glycol), 1,4-butanediol (1,4-butylene glycol), 1,6-hexanediol (1,6-hexamethylene glycol), 2-methyl-1,3-propanediol (trade name MPDiol Glycol® from Arco Chemical), 2,2-dimethyl-1,3-propanediol (neopentyl glycol), 1,4-bis(hydroxymethyl)cyclohexane (cyclohexanedimethanol), 1,2,3-propanetriol (glycerol), 2-hydroxymethyl-2-methyl-1,3-propanol (trimethylol-ethane), 2-ethyl-2-hydroxymethyl-1,3-propanediol (tri-methylolpropane), 2,2-bis(hydroxymethyl)-1,3-propane-diol (pentaerythritol).

The component (B) (ii), which is present in a proportion of from 0.8 to 6% by weight and preferably from 1.6 to 5% by weight, comprises at least one higher molecular weight polyol having two or more OH groups which are reactive toward polyisocyanates and a molecular mass of from 500 to 4000 dalton, but preferably a molecular mass of from 1000 to 2000 dalton. Suitable higher molecular weight polymeric polyols which can be used are, for example, commercial polyalkylene glycols (e.g. Voranol grades from Dow Chemical, polyTHF grades from BASF), aliphatic or aromatic polyester polyols (e.g. Bester grades from Poliolchimica), polycaprolactone polyols (e.g Capa grades from Solvany Interox), polycarbonate polyols (e.g Desmophen C 200 from Bayer). The term polyalkylene glycols refers, in particular, to polyethylene glycols, polypropylene glycols, mixed polyglycols based on ethylene oxide and propylene oxide and also to polytetramethylene glycols or polytetrahydrofurans.

Preference is given to using linear or bifunctional polypropylene glycols.

The component (B) (iii), which is present in a proportion of from 1,2 to 3.5% by weight and preferably from 1.6 to 3% by weight and has a preferred molecular mass of from 100 to 200 dalton, comprises at least one anionically modifiable polyol having two or more carboxyl groups which are inert toward polyisocyanates and can be completely or partly converted into carboxylate groups in the presence of amines or other suitable bases. As dispersant polyols, it is possible to use bishydroxyalkanecarboxylic acids such as dimethylolacetic acid, dimethylolpropionic acid, dimethylolbutyric acid, dimethylolvaleric acid, citric acid, tartaric acid, but preference is given to using dimethylolpropionic acid or 2-hydroxymethyl-2-methyl-3-hydroxypropanoic acid (trade name DMPA® from Mallinckrodt). The reactivity of the carboxyl groups toward the polyisocyanates can be disregarded under the reaction conditions prevailing here.

The component (C), which is present in a proportion of from 8 to 25% by weight and preferably from 12 to 20% by weight, comprises at least one polyisocyanate having two or more aliphatically or aromatically bound isocyanate groups. Suitable polyisocyanates are, in particular, the polyisocyanates which are adequately known in polyurethane chemistry or combinations thereof. Suitable aliphatic polyisocyanates are, for example, 1,6-diisocyanatohexane (HDI), 1-isocyanato-5-isocyanatomethyl-3,3,5-trimethylcyclohexane (IPDI), bis(4-isocyanatocyclohexyl)methane (H₁₂MDI), 1,3-bis-(1-isocyanato-1-methylethyl)benzene (m-TMXDI) or industrial isomer mixtures of the individual aliphatic polyisocyanates. Suitable aromatic polyisocyanates are, for example, 2,4-diisocyanatotoluene (TDI), bis-(4-isocyanatophenyl)methane (MDI) and, if appropriate, its higher homologues (polymeric MDI) or industrial isomer mixtures of the individual aromatic polyisocyanates. The aliphatic polyisocyanates are preferred over the aromatic polyisocyanates.

Furthermore, the “surface coating polyisocyanates” based on bis(4-isocyanatocyclohexyl)methane (H₁₂MDI), 1,6-diisocyanatohexane (HDI), 1-isocyanato-5-iso-cyanatomethyl-3,3,5-trimethylcyclohexane (IPDI) are also suitable in principle. The term “surface coating polyisocyanates” refers to derivatives of these diisocyanates which have allophanate, biuret, carbodiimide, isocyanurate, uretdione, urethane groups and in which the residual content of monomeric diisocyanates has been reduced to a minimum in accordance with the prior art. In addition, it is also possible to use modified polyisocyanates which can be obtained, for example, by hydrophilic modification of “surface coating polyisocyanates” based on 1,6-diisocyanatohexane (HDI) with polyether alcohols or by reaction of isocyanato-5-isocyanatomethyl-3,3,5-tri-methylcyclohexane (IPDI) with trimethylolpropane.

The solvent component (D), which is present in a proportion of from 0 to 10% by weight and preferably from 7 to 9% by weight, comprises at least one solvent which is inert toward polyisocyanates and is completely or partially miscible with water and remains in the polyurethane dispersion after the preparation or is completely or partly removed by distillation. Suitable solvents are, for example, high-boiling solvents such as N-methylpyrrolidone, diethylene glycol dimethyl ether, dipropylene glycol dimethyl ether (Proglyde DMM® from Dow), low-boiling solvents such as acetone, butanone or any mixtures thereof. Preference is given to high-boiling solvents such as N-methylpyrrolidone and dipropylene glycol dimethyl ether, which remain in the dispersion after the preparation and function as coalescence aids.

The neutralization component (E), which is present in a proportion of from 0.5 to 3% by weight and preferably from 1 to 2% by weight, comprises at least one amine or other suitable bases such as hydroxides which effect complete or partial neutralization of the carboxyl groups. Suitable bases are, for example, ammonia and tertiary amines such as dimethylethanolamine, dimethylisopropanolamine, N-methylmorpholine, tri-ethanolamine, triethylamine, triisopropylamine or mixtures of these bases. Preference is given to using bases such as ammonia, triethylamine, dimethyl-ethanolamine, dimethylisopropanolamine. Bases based on alkali metal hydroxides such as lithium hydroxide, sodium hydroxide or potassium hydroxide are likewise suitable. A neutralization or anionic modification of the polyurethane prepolymers is effected by means of the preferred bases before or during dispersion. This converts the carboxyl groups of the polyurethane prepolymers into carboxylate groups. The neutralization component (E) is preferably used in such an amount that the degree of neutralization is from 80 to 100 equivalent-%, but preferably from 90 to 100 equivalent-%, based on the free carboxyl groups present.

The siccative component (F), which is present in a proportion of from 0 to 0.5% by weight and preferably from 0.1 to 0.5% by weight, comprises mixtures of water-emulsifiable active and auxiliary dryers. These siccatives or dryers are in general organometallic metal soaps dissolved in aliphatic or aromatic solvents or conventional metal salts. Dryers act as catalysts to accelerate the decomposition of the peroxides formed as intermediates in the presence of oxygen and thus accelerate oxidative drying or crosslinking. Active dryers are based on metals which have a plurality of oxidation states and can undergo redox reactions, e.g. cobalt, manganese. Auxiliary dryers have a drying action only in combination with active dryers and are based on metals having only one oxidation state, e.g. barium, calcium, zinc. Preference is given to using water-emulsifiable active and auxiliary dryers or water-emulsifiable combination dryers, e.g. dryers based on cobalt, manganese, barium, zinc, calcium.

The polyamine component (G), which is present in a proportion of from 0.5 to 3% by weight and preferably from 1 to 2% by weight, comprises at least one polyamine having two or more amino groups which are reactive toward polyisocyanates. Suitable amines are, for example, adipic dihydrazide, ethylenediamine, diethylenetriamine, dipropylenetriamine, hexamethylene-diamine, hydrazine, isophorone diamine, N-(2-amino-ethyl)-2-aminoethanol, adducts of salts of 2-acryl-amido-2-methylpropane-1-sulfonic acid (AMPS) and ethylenediamine or any combinations of these polyamines. Preference is given to using bifunctional polyamines such as ethylenediamine. Chain extension of the polyurethane prepolymers is effected by means of the polyamine component (G) . The isocyanate groups of the polyurethane prepolymers are converted into urea groups in this reaction. The degree of chain extension brought about by means of these polyamines is preferably from 50 to 100 equivalent-%, but in particular from 70 to 100 equivalent-%, based on the free isocyanate groups of the prepolymer which are present. The remaining isocyanate groups of the polyurethane prepolymers are likewise converted into urea groups or possibly into allophanate or biuret groups in the reaction with water.

The preferred composition of the polyurethane dispersion of the invention is from >12 to 20% by weight of the component (A), from 0.4 to 1% by weight of the component (B) (i), from 1.6 to 5% by weight of the component (B) (ii), from 1.6 to 3% by weight of the component (B) (iii), from 12 to 20% by weight of the component (C), from 7 to 9% by weight of the component (D), from 1 to 2% by weight of the component (E), from 0.1 to 0.5% by weight of the component (F), from 1 to 2% by weight of the component (G) and water as balance.

The solids content of the polyurethane dispersion of the invention can vary within wide limits. In particular, it is from 30 to 60% by weight, preferably from 35 to 55% by weight, with the polyurethane resin usually having a molecular mass of from 50 000 to 100 000 dalton.

The preparation of the polyurethane dispersion of the invention is relatively unproblematical and can be carried out by customary methods using customary apparatuses.

The synthesis of polyurethane dispersions is described in detail in many publications, e.g. J. W. Rosthauser, K. Nachtkamp “Wäβrige Polyurethan-Dispersionen”, Firmenschrift, Bayer A G; R. Arnoldus, “Water-based Urethane Dispersions” in “Waterborne Coatings”, pp. 179-198, Elsevier, London 1990.

In reaction stage a), a polyurethane prepolymer having terminal isocyanate groups and lateral carboxyl groups is prepared from the components (A) to (C) by the methods customary in polyurethane chemistry. This prepolymer may further comprise a suitable solvent component (D) to reduce the viscosity.

In a preferred embodiment, the components (A), (B) and, if desired, (D) are homogenized and subsequently reacted with the component (C). For this purpose, it is possible either to add or meter the component (C) to/into the mixture of the components (A), (B) and, if desired, (D) over a period of from a few minutes to a few hours or, as an alternative, to add or meter the mixture of the components (A), (B) and, if desired, (D) to/into the component (C) over a period of from a few minutes to a few hours. The NOC/OH equivalent ratio of the components (A), (B) (polyols) and (C) (polyisocyanates) is in the range from 1.2 to 2.0, but preferably in the range from 1.4 to 1.8. The reaction mixture is stirred at from 60° C. to 120° C., but preferably from 80° C. to 100° C., utilizing the exothermic nature of the polyaddition reaction until the calculated NCO content has been reached.

The reaction a) of the components (A) to (C), if desired in the presence of the component (C), can be carried out in the presence or absence of catalysts. If necessary, these catalysts are added in amounts of from 0.01 to 1% by weight, based on the reaction mixture. Customary catalysts for polyaddition reactions on polyisocyanates are, for example, dibutyltin oxide, dibutyltin dilaurate, triethylamine, tin(II) octoate, 1,4-diazabicyclo[2.2.2]octane (DABCO), 1,4-diaza-bicyclo[3.2.0]-5-nonene (DBN), 1,5-diazabicyclo[5.4.0]-7-undecene (DBU).

Subsequent to reaction stage a), the prepolymer is allowed to react with the neutralization component (E) and, if desired, the siccative component (F) in stage b), thus achieving the anionic modification necessary for stabilizing the polyurethane dispersion. The neutralization component (E) is either mixed into the prepolymer before dispersion (direct neutralization) or is initially charged in the aqueous phase (indirect neutralization). The siccative component (F) can likewise be mixed into the prepolymer prior to dispersion or be initially charged in the aqueous phase.

Subsequent to the reaction stage b), the prepolymer is dispersed in water and the high molecular weight polyurethane dispersion is built up by reaction with the chain extension component (G) in stage c). During the dispersion step, the polyurethane prepolymer is transferred into the aqueous phase and a polyurethane prepolymer dispersion is formed therefrom. The terms “dispersion step” and “dispersion” allow for a dissolved component to be present in addition to the dispersed components.

The polyurethane prepolymer can be transferred into the aqueous phase by stirring the prepolymer into the aqueous phase or, alternatively, stirring the aqueous phase into the prepolymer.

To improve the dispersibility of the polyurethane prepolymers, it is also possible to add, if desired, external ionic and nonionic emulsifiers such as ethoxylated nonylphenol.

In the chain extension reaction, the polyurethane prepolymer dispersion is reacted with the chain extension component (G) which has reactive amino groups and reacts with isocyanate groups significantly more quickly than does water. Chain extension of the polyurethane prepolymer dispersion leads to an increase in the molecular mass and to the formation of a high molecular weight polyurethane-polyurea dispersion or the self-crosslinking polyurethane dispersion of the invention.

The solvent component which may be present remains in the dispersion after the preparation (prepolymer mixing process) and/or is completely or partly removed by distillation (solvent process or combination solvent process/prepolymer mixing process). Subsequent removal of the solvent by means of conventional or azeotropic distillation or else by stripping with an inert gas stream is carried out only in the case of particularly demanding requirements in respect of the residual content of organic solvents. The prepolymer mixing process is preferred for the preparation of the self-crosslinking polyurethane dispersion of the invention.

The self-crosslinking polyurethane dispersion, which according to the invention is oxidatively drying, can be used as significant or sole binder for high-quality aqueous paints and varnishes or coatings. In addition, the additives for stabilization in production and storage, for film formation, for film quality and for processing of the coating which are adequately known from surface coatings technology can be added to these paints and varnishes and coatings. These additives can be added during the synthesis of the self-crosslinking polyurethane dispersion of the invention if the preparation process is not adversely affected thereby. The one-component paints and varnishes and coatings produced on the basis of the self-crosslinking polyurethane dispersion are suitable for all applications which have a demanding requirement profile, e.g. the painting, varnishing and coating of the surfaces of mineral building materials such as concrete, gypsum plaster, cement; wood and wood materials such as particleboards, wood fiberboards, paper; metal; plastics. These paints and varnishes and coatings are pigmented or transparent topcoats, fillers, primers, sealants for predominantly building applications. The paints and varnishes and coatings produced are applied by means of the methods known from surface coatings technology, e.g. flooding, pouring, doctorblade coating, spraying, painting, dipping, rolling.

Aqueous paints and varnishes and coatings based on the self-crosslinking polyurethane dispersion of the invention dry at room temperature, under forced heat drying or under baking conditions to give glossy, hard and clear coatings. Drying at room temperature takes, depending on the substrate, from 2 to 3 hours..

The polyurethane dispersion of the invention is also very suitable as one-component adhesive or sealant in the building sector.

The advantages of the polyurethane dispersion of the invention are its technically simple preparation, with the properties of the polyurethane dispersion and the polyurethane films being able to be tailored via the polyol components, and the excellent drying capability and the other good use properties such as hardness and chemical resistance when used as binder for high-quality paints and varnishes and coatings.

### SYNTHESIS EXAMPLES

### Example 1

### Diol Modified With Fatty Acid (FAM Diol)

564.62 g of an epoxy resin based on bisphenol A and having an epoxide number of 0.555 eq (100 g)⁻¹ (trade name Araldit GY 240 from Ciba-Geigy) and 879.79 g of a linseed oil fatty acid having an acid number of 200 mg KOH·g⁻¹ and an iodine number of 186 g I₂·(100 g)⁻¹ (trade name Nouracid LE 80 from Hanf & Nelles) were placed in a three-necked flask equipped with precision glass stirrer, reflux condenser, thermometer and nitrogen blanketing. After addition of 1.00 g of the catalyst tetrabutylammonium bromide, the mixture was stirred at 145-155° C. under a blanket of nitrogen for 16 hours. The course of the reaction was followed acidimetrically.

The following synthesis product was obtained:

| Appearance | Yellowish brown resin | |
|---|---|---|
| Viscosity | 2500 | mPa · s (20° C.) |
| Acid number | 1.2 | mg KOH · g⁻¹ |
| Hydroxyl number | 122.0 | mg KOH · g⁻¹ |
| Iodine number | 110 | g I₂ · (100 g)⁻¹ |
| Molecular mass | 920 | |

### Example 2

### Triol Modified With Fatty Acid (FAM Triol)

98.70 g of tris(2,3-epoxypropyl) isocyanurate (from Aldrich) having an epoxide number of 1.009 eq (100 g)⁻¹ and 279.65 g of a linseed oil fatty acid having an acid number of 200 mg KOH·g⁻¹ and an iodine number of 186 g I₂·(100g)⁻¹ (trade name Nouracid LE 80 from Hanf & Nelles) were placed in a three-necked flask equipped with precision glass stirrer, reflux condenser, thermometer and nitrogen blanketing. After addition of 0.50 g of the catalyst tetrabutylammonium bromide, the mixture was stirred at 150° C. under a blanket of nitrogen for 12 hours. The course of the reaction was followed acidimetrically.

The following synthesis product was obtained:

| Appearance | Yellowish brown resin | |
|---|---|---|
| Viscosity | 20 000 | mPa · s |
| Acid number | 4.0 | mg KOH · g⁻¹ |
| Hydroxyl number | 134.6 | mg KOH · g⁻¹ |
| Iodine number | 134 | g I₂ · (100 g)⁻¹ |
| Molecular mass | 1250 | |

### Example 3

### Self-Crosslinking Polyurethane Dispersion Based on FAM Diol and Polyether in a Ratio of 80:20

A mixture of 80.00 g of FAM diol similar to example 1 having a hydroxyl number of 114.7 mg KOH·g⁻¹, 20.00 g of a polypropylene glycol having a hydroxyl number of 112.2 mg KOH·g⁻¹ (trade name Voranol P1010 from Dow), 3.00 g of trimethylolpropane, 10.00 g of dimethylol-propionic acid and 20.00 g of N-methylpyrrolidone was placed in a four-necked flask equipped with precision glass stirrer, reflux consenser, thermometer and nitrogen blanketing. After addition of 66.07 g of isophorone diisocyanate (trade name Vestanat IPDI from Hüls), the mixture was stirred at 80-90° C. under a blanket of nitrogen until the calculated NCO content had been reached (NCO/OH=1.40). The course of the reaction was followed acidimetrically. After the polyaddition reaction was complete, an NCO content of 3.73% by weight (theory: 3.69% by weight) was found. The prepolymer was then diluted with 25.00 g of N-methylpyrrolidone, 0.05% by weight of Octa-Soligen dryer 123 Aqua, 0.15% by weight of Octa-Soligen cobalt 7% Aqua and 0.50% by weight of Octa-Soligen calcium 10% (trade names of Borchers), based on the solid prepolymer, were added as siccatives while stirring vigorously and the prepolymer was subsequently neutralized with the required amount of triethylamine.

Dispersion and chain extension: 190.00 g of the prepolymer were subsequently dispersed in 247.10 g of demineralized water with vigorous stirring and chain-extended by means of the required amount of ethylenediamine to increase the molecular mass.

A stable polyurethane dispersion having the following characteristics was obtained:

| Appearance | Opaque liquid | |
|---|---|---|
| Solids content | 36.3% | by weight |
| pH | 7.8 | |
| Brookfield viscosity | 70 | mPa · s (20° C.) |
| Mean particle size | 136 | nm |
| NMP content | 8.7% | by weight |
| Iodine content | 22 | g I₂ · (100 g)⁻¹ |

### Example 4

### Self-Crosslinking Polyurethane Dispersion Based on FAM Diol, FAM Triol and Polyether in a Ratio of 80:10:10

A mixture of 80.00 g of FAM diol from example 1 having a hydroxyl number of 122.0 mg KOH·g⁻¹, 10.00 g of FAM triol from example 2 having a hydroxyl number of 134.6 mg KOH·g⁻¹, 10.00 g of a polypropylene glycol having a hydroxyl number of 112.2 mg KOH·g⁻¹ (trade name Voranol P1010 from Dow), 3.00 g of trimethylolpropane, 11.00 g of dimethylolpropionic acid and 20.00 g of N-methylpyrrolidone was placed in a four-necked flask equipped with precision glass stirrer, reflux condenser, thermometer and nitrogen blanketing. After addition of 74.86 g of isophorone diisocyanate (trade name Vestanat IPDI from Hüls), the mixture was stirred at 80-90° C. under a blanket of nitrogen until the calculated NCO content had been reached (NCO/OH=1.50). The course of the reaction was followed acidimetrically. After the polyaddition reaction was complete, an NCO content of 4.23% by weight (theory: 4.52% by weight) was found. The prepolymer was then diluted with 25.00 g of N-methylpyrrolidone, 0.05% by weight of Octa-Soligen dryer 123 Aqua, 0.15% by weight of Octa-Soligen cobalt 7% Aqua and 0.50% by weight of Octa-Soligen calcium 10% (trade names of Borchers), based on the solid prepolymer, were added as siccatives while stirring vigorously and the prepolymer was subsequently neutralized with the required amount of triethylamine.

Dispersion and chain extension: 215.00 g of the prepolymer were subsequently dispersed in 247.30 g of demineralized water with vigorous stirring and chain-extended by means of the required amount of ethylenediamine to increase the molecular mass.

A stable polyurethane dispersion having the following characteristics was obtained:

| Appearance | Opaque liquid | |
|---|---|---|
| Solids content | 38.6% | by weight |
| pH | 7.5 | |
| Brookfield viscosity | 38.6 | mPa · s (20° C.) |
| Mean particle size | 152 | nm |
| NMP content | 8.8% | by weight |
| Iodine content | 25 | g I₂ · (100 g)⁻¹ |

### Example 5

### Self-Crosslinking Polyurethane Dispersion Based on FAM Diol, FAM Triol and Polyether in a Ratio of 70:10:20

Synthesis of the prepolymer

A mixture of 70.00 g of FAM diol from example 1 having a hydroxyl number of 122.0 mg KOH·g⁻¹, 10.00 g of FAM triol from example 2 having a hydroxyl number of 134.6 mg KOH·g⁻¹, 20.00 g of a polypropylene glycol having a hydroxyl number of 112.2 mg KOH·g⁻¹ (trade name Voranol P1010 from Dow), 3.00 g of trimethylolpropane, 12.00 g of dimethylolpropionic acid and 20.00 g of N-methylpyrrolidone was placed in a four-necked flask equipped with precision glass stirrer, reflux condenser, thermometer and nitrogen blanketing. After addition of 82.19 g of isophorone diisocyanate (trade name Vestanat IPDI from Hüls), the mixture was stirred at 80-90° C. under a blanket of nitrogen until the calculated NCO content had been reached (NCO/OH=1.60). The course of the reaction was followed acidimetrically. After the polyaddition reaction was complete, an NCO content of 5.38% by weight (theory: 5.36% by weight) was found. The prepolymer was then diluted with 25.00 g of N-methylpyrrolidone, 0.05% by weight of Octa-Soligen dryer 123 Aqua, 0.15% by weight of Octa-Soligen cobalt 7% Aqua and 0.50% by weight of Octa-Soligen calcium 10% (trade names of Borchers), based on the solid prepolymer, were added as siccatives while stirring vigorously and the prepolymer was subsequently neutralized with the required amount of triethylamine.

Dispersion and chain extension:

230.00 g of the prepolymer were subsequently dispersed in 255.90 g of demineralized water with vigorous stirring and chain-extended by means of the required amount of ethylenediamine to increase the molecular mass.

A stable polyurethane dispersion having the following characteristics was obtained:

| Appearance | Opaque liquid | |
|---|---|---|
| Solids content | 39.3% | by weight |
| pH | 7.5 | |
| Brookfield viscosity | 330 | mPa · s (20° C.) |
| Mean particle size | 287 | nm |
| NMP content | 8.6% | by weight |
| Iodine content | 24 | g I₂ · (100 g)⁻¹ |

### Example 6

### Self-Crosslinking Polyurethane Dispersion Based on FAM Diol, FAM Triol and Polyether in a Ratio of 65:15:20

A mixture of 65.00 g of FAM diol from example 1 having a hydroxyl number of 122.0 mg KOH·g⁻¹, 15.00 g of FAM triol from example 2 having a hydroxyl number of 134.6 mg KOH·g⁻¹, 20.00 g of a polypropylene glycol having a hydroxyl number of 112.2 mg KOH·g⁻¹ (trade name Voranol P1010 from Dow), 3.00 g of trimethylolpropane, 13.00 g of dimethylolpropionic acid and 20.00 g of N-methylpyrrolidone was placed in a four-necked flask equipped with precision glass stirrer, reflux condenser, thermometer and nitrogen blanketing. After addition of 85.04 g of isophorone diisocyanate (trade name Vestanat IPDI from Hüls), the mixture was stirred at 80-90° C. under a blanket of nitrogen until the calculated NCO content had been reached (NCO/OH=1.60). The course of the reaction was followed acidimetrically. After the polyaddition reaction was complete, an NCO content of 5.30% by weight (theory: 5.48% by weight) was found. The prepolymer was then diluted with 25.00 g of N-methylpyrrolidone, 0.05% by weight of Octa-Soligen dryer 123 Aqua, 0.15% by weight of Octa-Soligen cobalt 7% Aqua and 0.50% by weight of Octa-Soligen calcium 10% (trade names of Borchers), based on the solid prepolymer, were added as siccatives while stirring vigorously and the prepolymer was subsequently neutralized with the required amount of triethylamine.

Dispersion and chain extension:

220.00 g of the prepolymer were subsequently dispersed in 298.20 g of demineralized water with vigorous stirring and chain-extended by means of the required amount of ethylenediamine to increase the molecular mass.

A stable polyurethane dispersion having the following characteristics was obtained:

| Appearance | Opaque liquid | |
|---|---|---|
| Solids content | 35.7% | by weight |
| pH | 7.4 | |
| Brookfield viscosity | 3000 | mPa · s (20° C.) |
| Mean particle size | 258 | nm |
| NMP content | 7.6% | by weight |
| Iodine content | 22 | g I₂ · (100 g)⁻¹ |

### Comparative Example

### Polyurethane Dispersion Based on Bisphenol A Propoxylate Without Oxidatively Drying Components

A mixture of 100.00 g of a bisphenol A propoxylate (3.6 PO/phenol) having a hydroxyl number of 174 mg KOH·g⁻¹ (from Aldrich), 9.50 g of dimethylolpropionic acid and 10.00 g of N-methylpyrrolidone were placed in a four-necked flask equipped with precision glass stirrer, reflux condenser, thermometer and nitrogen blanketing. After addition of 70.29 g of isophorone diisocyanate (trade name Vestanat IPDI from Hüls), the mixture was stirred at 80-90° C. under a blanket of nitrogen until the calculated NCO content had been reached (NCO/OH=1.40). The course of the reaction was followed acidimetrically. After the polyaddition reaction was complete, an NCO content of 3.91% by weight (theory: 3.83% by weight) was found. The prepolymer was then neutralized with the required amount of triethylamine while stirring vigorously.

Dispersion and chain extension:

175.00 g of the prepolymer were subsequently dispersed in 299.40 g of demineralized water with vigorous stirring and chain-extended by means of the required anount of ethylenediamine to increase the molecular mass.

A stable polyurethane dispersion having the following characteristics was obtained:

| Appearance | Opaque liquid | |
|---|---|---|
| Solids content | 27.4% | by weight |
| pH | 7.8 | |
| Brookfield viscosity | 1670 | mPa · s (20° C.) |
| Mean particle size | 222 | nm |

TABLE I
Examples 7 to 18
Self-crosslinking polyurethane dispersions based on FAM diol, FAM
triol and polymeric polyols The polyurethane dispersions were prepared
by a method analogous to that described in examples 3 to 6.

| | FAM | FAM | | Polymeric | | | | | |
|---|---|---|---|---|---|---|---|---|---|
| | diol | triol | TMP | polyol | DMPA | NCO/ | IPDI/ | NMP | Dryer |
| Example | [g] | [g] | [g] | No. | [g] | OH | H₁₂MDI | [g] | No. |
| 7 | 80.00 | — | 3.00 | 1 | 10.00 | 1.40 | 100/0 | 45.00 | 1 |
| 8 | 80.00 | — | 3.00 | 1 | 10.00 | 1.40 | 100/0 | 45.00 | 3 |
| 9 | 80.00 | — | 3.00 | 1 | 10.00 | 1.40 | 100/0 | 45.00 | — |
| 10 | 80.00 | — | 3.00 | 1 | 12.00 | 1.60 | 100/0 | 20.00 | 1 |
| 11 | 80.00 | — | 4.00 | 1 | 12.00 | 1.60 | 100/0 | 45.00 | 1 |
| 12 | 80.00 | — | 4.00 | 1 | 13.00 | 1.60 | 0/100 | 45.00 | 1 |
| 13 | 80.00 | — | 4.00 | 1 | 12.50 | 1.60 | 50/50 | 45.00 | 1 |
| 14 | 80.00 | 10.00 | — | 1 | 10.00 | 1.40 | 100/0 | 45.00 | 3 |
| 15 | 75.00 | 15.00 | — | 1 | 10.00 | 1.40 | 100/0 | 45.00 | 3 |
| 16 | 70.00 | 20.00 | — | 1 | 10.00 | 1.40 | 100/0 | 45.00 | 3 |
| 17 | 80.00 | — | 3.00 | 2 | 10.00 | 1.40 | 100/0 | 45.00 | 2 |
| 18 | 80.00 | — | 3.00 | 3 | 10.00 | 1.40 | 100/0 | 45.00 | 2 |

| | | | Dryer (% by weight based | |
|---|---|---|---|---|
| Polymeric polyol | | IPDI/H₁₂MDI | on solid prepolymer) | |
| 1 | 20.00 g of Dow Voranol | Ratio of equivalents of | 1 | 0.30% of Borchers Octa |
| | P1010 polypropylene | isophorone diisocyanate | | Soligen dryer 123 Aqua |
| | glycol, Mₙ = 1000 dalton | (IPDI) and bis(4-iso- | 2 | 0.05% of Borchers Octa |
| 2 | 20.00 g of Poliolchimica | cyanatocyclohexyl)methane | | Soligen dryer 123 Aqua |
| | Bester 195 polyester | (H₁₂MDI) | | 0.15% of Borchers Octa |
| | polyol, Mₙ = 959 dalton | | | Soligen cobalt 7% Aqua |
| 3 | 20.00 g of Bayer | | | 0.50% of Borchers Octa |
| | Desmophen C200 | | | Soligen calcium 10% |
| | polycarbonate polyol, | | 3 | 0.12% of OMG manganese |
| | Mₙ = 2000 dalton | | | Hydro-Cure III |
| | | | | 0.24% of OMG DRI-Rx HF |

TABLE II
Examples 7 to 18
Self-crosslinking polyurethane dispersions based on FAM diol, FAM triol and polymeric polyols

| | NCO content | | | Viscosity | Particle size | | |
|---|---|---|---|---|---|---|---|
| | Th./found | Solids content | | (20° C.) | Mean diameter | Iodine number | NMP content |
| Example | [% by weight] | [% by weight] | pH | [mPas] | [nm] | [g I₂ · (100 g)⁻¹] | [% by weight] |
| 7 | 3.66/3.74 | 37.8 | 8.3 | 2500 | 36 | 18 | 9.1 |
| 8 | 3.69/3.71 | 37.3 | 7.7 | 90 | 126 | 23 | 9.0 |
| 9 | 3.47/3.49 | 37.6 | 7.8 | 70 | 120 | 23 | 9.1 |
| 10 | 5.36/5.28 | 37.2 | 8.1 | 450 | 36 | 19 | 3.6 |
| 11 | 5.37/5.26 | 38.8 | 7.8 | 100 | 34 | 19 | 8.4 |
| 12 | 5.17/5.11 | 37.6 | 7.9 | 50 | 32 | 18 | 7.4 |
| 13 | 5.31/5.12 | 36.0 | 7.8 | 25 | 33 | 21 | 7.4 |
| 14 | 3.31/3.39 | 37.3 | 7.6 | 100 | 120 | 24 | 8.9 |
| 15 | 3.25/3.49 | 32.9 | 8.0 | 260 | 166 | 22 | 7.9 |
| 16 | 3.26/3.35 | 36.0 | 7.6 | 110 | 116 | 24 | 8.6 |
| 17 | 3.65/3.57 | 38.3 | 7.7 | 40 | 146 | 22 | 9.2 |
| 18 | 3.89/3.89 | 37.3 | 7.6 | 50 | 183 | 22 | 9.0 |

The NCO content theory/found is based on the polyurethane prepolymer before neutralization and additition of siccatives.

All further data are based on the polyurethane dispersion after neutralization, addition of siccatives, dispersion and chain extension.

### Use Examples

Guide formulation for parquetry coatings based on the self-crosslinking polyurethane dispersions according to the invention

| Constituents | Amounts |
|---|---|
| Polyurethane dispersion | 98.2 g |
| Defoamer Byk Chemie BYK-024 | 0.8 g |
| Surfactant Air Products Surfynol 104E | 0.5 g |
| Wetting agent Du Pont Zonyl FSN | 0.1 g |
| Thickener Rohm & Haas Acrysol RM 8 | 0.4 g |

TABLE III
König hardness of parquetry coatings based
on the self-crosslinking polyurethane dispersion according
to the invention (initial hardness)

| | |
|---|---|
| | König hardness [s] |
| Basis | (layer thickness: 100-200 μm) |

| Example | 12 h | 24 h | 4 d | 6 d |
|---|---|---|---|---|
| 3 | 15 | 39 | 96 | 96 |
| 4 | 14 | 38 | 82 | 96 |
| 5 | 15 | 18 | 87 | 98 |
| 6 | 20 | 40 | 105 | 106 |
| Comparison¹⁾ | 15 | 25 | 46 | 49 |

¹⁾Zeneca Resins NeoRez R-2001 Commercial, oxidatively drying polyurethane dispersion modified with fatty acid
Solids content: 35% by weight,
NMP content: 9.8% by weight

TABLE IV
König hardness of parquetry coatings based on the self-crosslinking
polyurethane dispersions according to the invention (overview)

| | König hardness [s] | | |
|---|---|---|---|
| Basis | [Layer thickness: 100-200 μm] | | |
| Example | 6 d | 12 d | 16 d |
| 3 | 96 | 103 | 109 |
| 4 | 96 | 115 | 117 |
| 5 | 98 | 120 | 120 |
| 6 | 106 | 144 | 144 |
| 7 | 48 | 58 | 58 |
| 8 | 19 | 23 | 23 |
| 9 | 72 | 83 | 83 |
| 10 | 73 | 85 | 85 |
| 11 | 92 | 111 | 111 |
| 12 | 70 | 80 | 80 |
| 13 | 110 | 114 | 114 |
| 14 | 18 | 22 | 23 |
| 15 | 19 | 25 | 25 |
| 16 | 22 | 29 | 32 |
| 17 | 29 | 36 | 36 |
| 18 | 65 | 94 | 94 |
| Comparative example | 25 | 25 | 25 |
| Comparison¹⁾ | 49 | 77 | 79 |

The chemical resistance of the paints and varnishes and coatings produced from the polyurethane dispersions according to the invention is in all cases good to very good. The resistance toward 2-butane (MEK), 2-propanol/methanol/water==48:48:4% by weight, water, 205 strength by weight sodium hydroxide solution, 20% strength by weight acetic acid were tested.

The drying characteristics of the paints and varnishes and coatings produced from the self-crosslinking polyurethane dispersions according to the invention can be tailored by selection of the unsaturated fatty acid component (A) capable of oxidative drying, the polyol component (B), the polyisocyanate component (C) and the siccative component (F) and matched to the respective requirements.

1-25. (canceled)

26. A self-crosslinking high molecular weight polyurethane dispersion based on oxidatively drying diols and/or triols, wherein the reaction components comprise:
(A) from >12 to 30% by weight of an unsaturated fatty acid component which is capable of oxidative drying and comprises at least one unsaturated fatty acid derivative or fatty acid epoxy ester having two or three reactive hydroxyl groups,
(B) from 2 to 11% by weight of a polyol component comprising
(i) from 0 to 1.5% by weight of at least one low molecular weight polyol having two or more reactive hydroxyl groups and a molecular mass of from 60 to 150 dalton,
(ii) from 0.8 to 6% by weight of at least one higher molecular weight polyol having two or more reactive hydroxyl groups and a molecular mass of from 500 to 4000 dalton,
(iii) from 1.2 to 3.5% by weight of at least one anionically modified polyol having two or more reactive hydroxyl groups and one or more carboxyl groups which are inert toward polyisocyanates,
(C) from 8 to 25% by weight of a polyisocyanate component comprising at least one polyisocyanate or polyisocyanate derivative having two or more aliphatic or aromatic isocyanate groups,
(D) from 0 to 10% by weight of a solvent component comprising at least one solvent which is inert toward polyisocyanates and is completely or partially miscible with water,
(E) from 0.5 to 3% by weight of a neutralization component comprising at least one base based on an amine or hydroxide,
(F) from 0 to 0.5% by weight of a siccative component comprising at least one water-emulsifiable active or auxiliary dryer,
(G) from 0.5 to 3% by weight of a chain extension component comprising at least one polyamine having two or more reactive amino groups, and water as the balance.

27. The polyurethane dispersion as claimed in claim 26, wherein said component (A) has an iodine number in the range from 100 to 150 g I₂·(100 g)⁻¹, a hydroxyl number of from 120 to 150 mg KOH·g⁻¹ and an acid number of from 1 to 5 mg KOH·g⁻¹.

28. The polyurethane dispersion as claimed in claim 26, wherein said component (A) has a viscosity of from 2500 to 25 000 mpa·s (20° C.).

29. The polyurethane dispersion as claimed in claim 26, wherein said component (A) comprises a reaction product of unsaturated fatty acids and aliphatic or aromatic epoxy resins or polyepoxides having two or three epoxide groups which are reactive toward fatty acid.

30. The polyurethane dispersion as claimed in claim 26, wherein said component (A) comprises a reaction product of at most triply unsaturated fatty acids having an iodine number of from 170 to 190 g I₂·(100 g)⁻¹ and aliphatic or aromatic epoxy resins or polyepoxides having an epoxide number of >0.5 eq·(100 g)⁻¹.

31. The polyurethane dispersion as claimed in claim 26, wherein said component (B) (i) comprises at least one low molecular weight polyol having a molecular mass of from 90 to 140 dalton.

32. The polyurethane dispersion as claimed in claim 26, wherein said component (B) (ii) comprises a polymeric polyol selected from the group consisting of polyalkylene glycols, aliphatic or aromatic polyester polyols, polycaprolactone polyols and polycarbonate polyols and combinations thereof.

33. The polyurethane dispersion as claimed in claim 32, wherein said component (B) (ii) comprises linear or bifunctional polypropylene glycols.

34. The polyurethane dispersion as claimed in claim 26 wherein said component (B) (ii) comprises at least one higher molecular weight polyol having a molecular mass of from 1,000 to 2,000 daltons.

35. The polyurethane dispersion as claimed in claim 26, wherein said component (B) (iii) comprises at least one bishydroxyalkanecarboxylic acid.

36. The polyurethane dispersion as claimed in claim 35, wherein said bishydroxyalkanecarboxylic acid is dimethylolpropionic acid.

37. The polyurethane dispersion as claimed in claim 26, wherein said component (B) (iii) comprises at least one anionically modified polyol having a molecular mass of from 100 to 200 daltons.

38. The polyurethane dispersion as claimed in claim 26, wherein said neutralization component (E) comprises ammonia and/or tertiary amines.

39. The polyurethane dispersion as claimed in claim 26, wherein said neutralization component (E) comprises an alkali metal hydroxide.

40. The polyurethane dispersion as claimed in claim 26, wherein said neutralization component (E) is present in such an amount that the degree of neutralization based on the free carboxyl groups is from 80 to 100 equivalent-%.

41. The polyurethane dispersion as claimed in claim 26, wherein said siccative component (E) comprises at least one of a metal soap or a metal salt.

42. The polyurethane dispersion as claimed in claim 26, wherein said chain extension component (G) is present in such an amount that the degree of chain extension is from 50 to 100 equivalent-%, based on the free isocyanate groups of the prepolymer.

43. The polyurethane dispersion as claimed in claim 26, wherein said component (A) is present in an amount of from >12 to 20% by weight; said component (B) (i) is present in an amount of from 0.4 to 1% by weight, said component (B) (ii) is present in an amount of from 1.6 to 5% by weight; said component (B) (iii) is present in an amount of from 1.6 to 3% by weight; said component (C) is present in an amount of from 12 to 20% by weight; said component (D) is present in an amount of from 7 to 9% by weight; said component (E) is present in an amount of from 1 to 2% by weight; said component (F) is present in an amount of from 0.1 to 0.5% by weight; said component (G) is present in an amount of from 1 to 2% by weight; and the balance is water.

44. The polyurethane dispersion as claimed in claim 26, wherein a NCO/OH equivalent ratio of the components (A), (B) and (C) is in the range from 1.2 to 2.0, preferably in the range from 1.4 to 1.8.

45. The polyurethane dispersion as claimed in claim 26, wherein a solids content is from 30 to 60% by weight.

46. The polyurethane dispersion as claimed in claim 26, wherein said polyurethane resin has a molecular mass of from 50,000 to 100,000 daltons.

47. A process for preparing the polyurethane dispersion as claimed in claim 26 comprising
a) reacting said components (A) to (C), optionally in said solvent component (D), and optionally in the presence of a catalyst, to form a polyurethane prepolymer;
b) subsequently reacting the prepolymer from stage a) with said neutralization component (E) and, optionally, with the siccative component (F); and
c) subsequently dispersing the prepolymer from stage b) in water reacting it with the chain extension component (G) to form the high molecular weight polyurethane dispersion.

48. The process as claimed in claim 47, wherein reaction stage a) is carried out at from 60° C. to 120° C.

49. The process as claimed in claim 47, wherein reaction stage (a) is carried out in the presence of from 0.01 to 1% by weight, based on the components (A) to (D), of a catalyst suitable for polyaddition reactions on a polyisocyanate.

50. A one-component paint, varnish, coating for the surfaces of a mineral building material selected from the group consisting of concrete, wood, a wood material, a paper, metal a plastic a one-component adhesive or a sealant in the building sector comprising a binder comprising the polyurethane dispersion of claim 26.
